(19) United States
(12) Patent Application Publication
(10) Pub. No.: US 2009/0187910 A1
(43) Pub. Date: Jul. 23, 2009

(54) METHOD AND SYSTEM FOR AUTOMATED SCHEDULE CONTROL

(75) Inventor: Yu-Hsia HSIAO, Taipei (TW)

Correspondence Address: QUINTERO LAW OFFICE, PC, 2210 MAIN STREET, SUITE 200, SANTA MONICA, CA, 90405, US

(73) Assignee: WISTRON CORP., TAIPEI HSIEN (TW)

(21) Appl. No.: 12/197,947

(22) Filed: Aug. 25, 2008

(30) Foreign Application Priority Data
Jan. 17, 2008 (TW) TW97101776

(51) Int. Cl. G06F 9/46; G06F 17/30; G06F 9/44

(52) U.S. Cl. 718/102; 707/10; 717/173; 707/E17.032

(57) ABSTRACT

A method for automated schedule control is disclosed. When a schedule appointment process is performed, an open services gateway initiative framework of an electronic device performs an automatic schedule control operation, detecting whether an execution for a schedule is required. If required, it is determined whether the schedule is an update operation. If so, a start or stop operation for a bundle corresponding to the schedule is performed. If not, the electronic device connects to a remote database at a preset time to determine whether a new manifest for the bundle corresponding to the schedule is detected. If detected, the new manifest is retrieved from the remote database and the bundle is accordingly updated thereto.

### CROSS REFERENCE TO RELATED APPLICATIONS

This Application claims priority of Taiwan Patent Application No. 97101776, filed on Jan. 17, 2008, the entirety of which is incorporated by reference herein.

### BACKGROUND OF THE INVENTION

1. Field of the Invention

The invention relates to the open services gateway initiative (OSGi), and more particularly to method and system for automated schedule control for the OSCi.

2. Description of the Related Art

The OSGi is defined in an open platform that enables applications and value-added service provided by a remote software service provider to be downloaded to a domestic gateway via the internet based on user requirements for automatic installation. Thus, service software and equipments developed by different companies can communicate with each other.

The OSGi structure comprises a framework, bundles, and services. The framework is designed on a Java virtual machine (VM), the bundles represent applications implemented on the framework, while the services represent interfaces provided by the bundles. A bundle downloaded from a remote terminal is automatically installed, preformed and shareware or services provided by the bundle are registered to the OSGi platform.

The OSGi framework is an integral information service platform, providing an implementation environment for bundles and dynamically adjusting life cycle for a bundle. The OSGi framework also enables a bundle implemented thereon to provide or use required services. Additionally, services can be shared between bundles to reduce development time or increase program functionality.

FIG. 1 is a schematic view of a life cycle of a bundle.

A life cycle of a bundle comprises INSTALLED, RESOLVED, STARTING, ACTIVE, STOPPING, AND UNINSTALLED states. When the bundle is stopped, the framework removes a service registered by the bundle while the event is reported to other bundles using the service.

A bundle is started and performed by the OSGi framework. Practically, a bundle represents a Java Archive file (JAR), comprising a Java class, an activator class, a manifest header, and resource files such as html web pages or Joint Photographic Experts Group (JPG) image files. The manifest header describes the attached information of a bundle and definition rules comprising an import-package, an export-package, a bundle-activator, an import service, an export-service, and so on.

Additionally, a bundle can represent provided functions with services. A service represents an interface, which can be accessed by other bundles. When a bundle provides a service, the framework reserve a corresponding service reference that a bundle needing the service can request and obtains the service via lightweight directory access protocol (LDAP) for the framework. With respect to the framework, an applicable application is generated by a series of services.

With respect to the current OSGi structure, a life cycle of a service (or a bundle) must be immediately controlled by a user. Although the OSGi also provides another start_level service to enable the framework to implement initialization to a specified bundle, it only avoids performing the setting of activation orders for bundles if services provided by another bundle are required but the bundle providing the services has not begun to result in errors, as shown in FIG. 2. In other words, a user must immediately implement start, stop or update operations to a bundle via the OSGi framework. The framework cannot automatically perform start, stop or update operations and can only control activation sequence of bundles, while the framework is activated, via a start_level service.

The OSGi framework comprises an activate_level service while each bundle also provides an individual start_level service. When the framework is activated, the activate_level service starts from activate_level=0 to compare a start_level of a bundle, determining whether a start_level of the bundle is equal to the current activate_level. When start_levels of all bundles are finished being compared, the activate_level is added by 1, and the comparison is repeated. The comparison between the activate_level and the start_level for another bundle is repeated until the activate_level is equal to the start_level.

When the framework is disabled, the described process is also performed to stop a bundle and the activate_level is sequentially subtracted by 1.

The start_level service, however, can only implement order initialization of starting or stopping to a bundle at a specified time. The start_level service cannot implement an update operation to a bundle. Additionally, if implementation of start, stop or update operations for a bundle at a specified time is required, a real-time operation must be performed using a computer, which cannot be automatically performed by the framework. For example, when a user wants to activate a web camera to monitor their home for safety reasons, they must connect to the Internet using a computer device to connect to the OSGi framework to activate a service for the web camera, which is inconvenient for the user.

Thus, a method and system for automated schedule control is desirable.

### BRIEF SUMMARY OF THE INVENTION

Methods for automated schedule control are provided. An exemplary embodiment of a method for automated schedule control applied to an electronic device capable of an OSCi framework comprises the following. When a schedule appointment process is performed, the OSCi framework performs an automatic schedule control operation to determine whether an execution for a schedule is required. If required, it is determined whether the schedule is an update operation. If so, a start or stop operation for a bundle corresponding to the schedule is performed. If not, the electronic device connects to a remote database at a preset time to determine whether a new manifest for the bundle corresponding to the schedule is detected. If detected, the new manifest is retrieved from the remote database and the bundle is accordingly updated thereto.

Systems for automated schedule control are provided. An exemplary embodiment of a system for automated schedule control comprises an electronic device and a client. The electronic device further comprises a schedule service module, an OSGi framework, and a bundle. The client, by wire or wireless connection, connects to the electronic device and enables the electronic device to connect to a remote database using the OSGi framework to perform a schedule appointment process. The OSCi framework performs an automated schedule control operation and when a schedule appointment process is performed, determines whether an execution for a schedule is required If the execution for the schedule is required, the OSCi framework determines whether the schedule is an update operation. If the schedule is not an update operation, the OSCi framework performs a start or stop operation for the bundle corresponding to the schedule. If the schedule is an update operation, the OSCi framework enables the electronic device to connect to a remote database at a preset time to determine whether a new manifest for the bundle corresponding to the schedule is detected, and, if a new manifest is detected, retrieves the new manifest from the remote database and updates the bundle according to the new manifest.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a schematic view of a life cycle of a bundle;

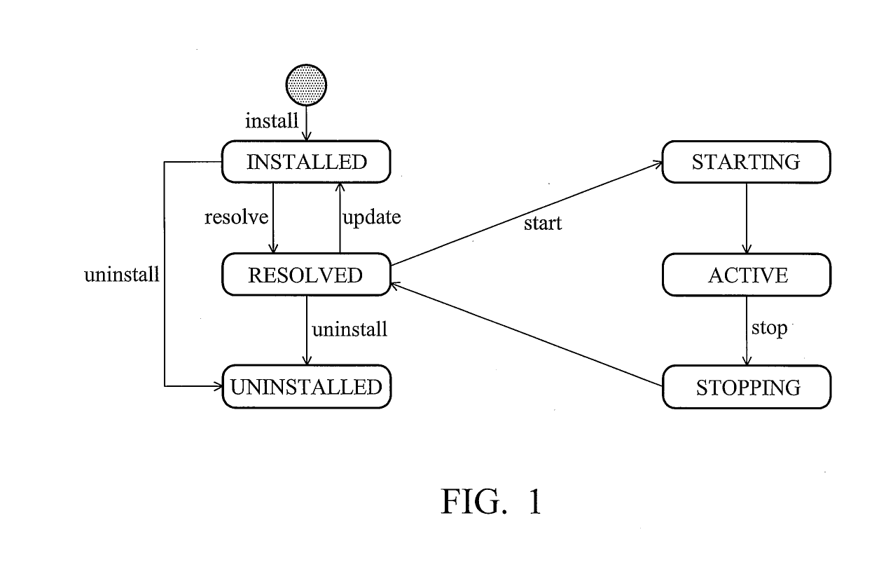

FIG. 2 is a flowchart of starting a bundle;

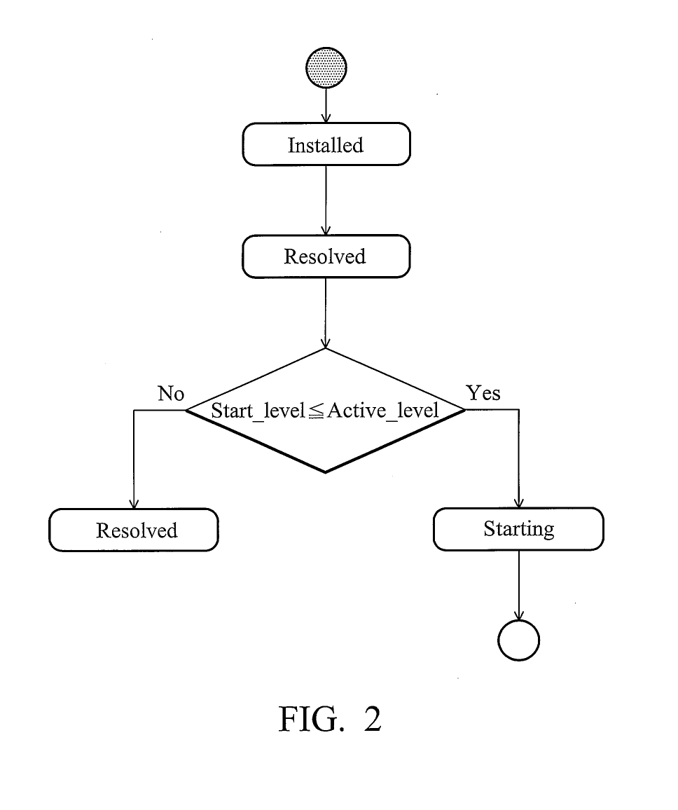

FIG. 3 is a flowchart of an embodiment of a method for a schedule appointment process;

FIG. 4 is a flowchart of an embodiment of a method for automated schedule control; and

FIG. 5 is a schematic view of an embodiment of a system for automated schedule control.

### DETAILED DESCRIPTION OF THE INVENTION

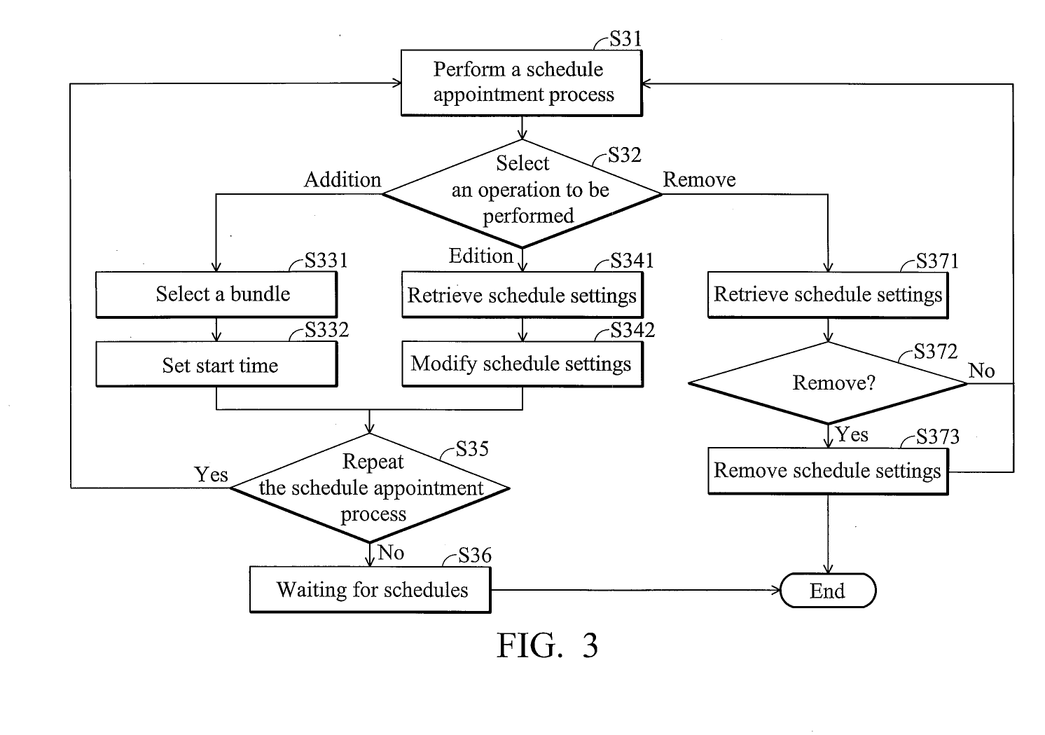

Several exemplary embodiments of the invention are described with reference to FIGS. 3 through 5, which generally relate to automated schedule control. It is to be understood that the following disclosure provides various different embodiments as examples for implementing different features of the invention. Specific examples of components and arrangements are described in the following to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various described embodiments and/or configurations.

The invention discloses a method and system for automated schedule control for an OSCi.

An embodiment of the method for automated schedule control provides a new schedule service to provide users for schedule control of a life cycle of a bundle and automatic update of a framework.

The schedule service enables users to implement start, stop or update schedules on each bundle and, when the framework is activated, enables a bundle to automatically start, stop, or update at a specified time, providing more flexible operations. The schedule service also provides the framework for automatically checking whether an update version is provided and, if provided, automatically performing an update operation even if an update appointment is not scheduled.

FIG. 3 is a flowchart of an embodiment of a method for a schedule appointment process.

A schedule appointment process is performed (step S31) and an operation to be performed is selected (step S32). If a schedule addition is performed, a bundle for schedule addition is selected (step S331) and start time for the bundle is set (step S332). If a schedule edition is performed, a bundle for schedule edition is retrieved (step S341) and schedule settings for the bundle are modified (step S342). When schedule addition or edition is complete, it is determined whether the schedule appointment process has been repeated (step S35), and, if so, the process proceeds to step S31, and, if not, schedules waiting to be performed are set (step S36). If a schedule remove is performed, schedule settings for a bundle to be removed are retrieved (step S371) and it is determined whether the schedule settings have been removed (step S372). If so, the schedule settings are removed (step S373) and the process proceeds to step S31.

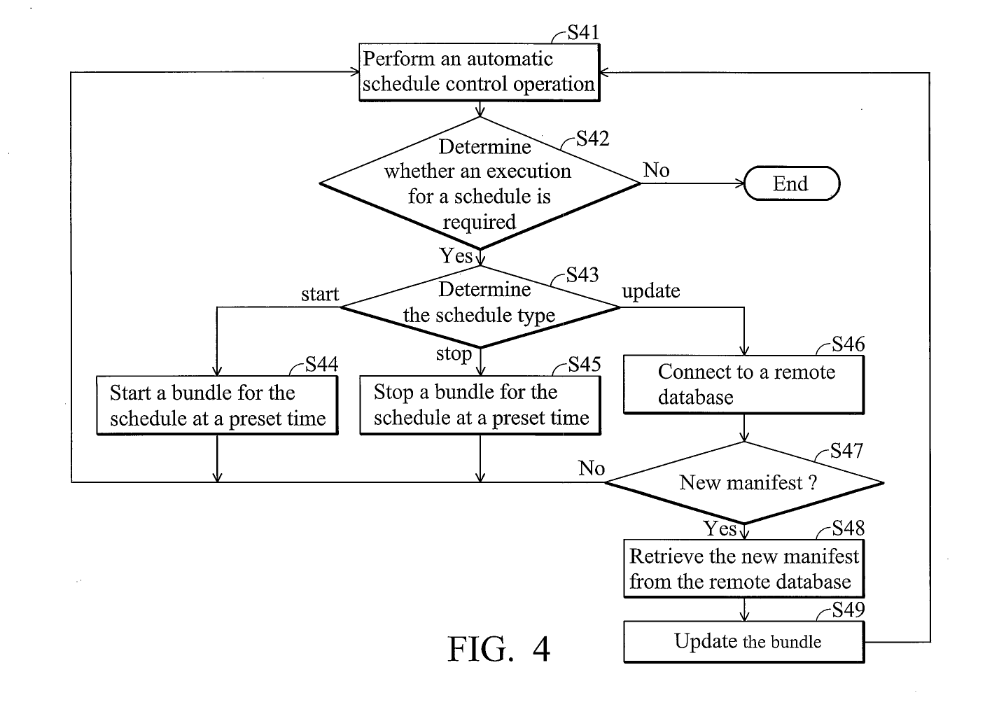

FIG. 4 is a flowchart of an embodiment of a method for automated schedule control.

The method for automated schedule control is applied to an electronic device capable of an OSCi framework. When a schedule appointment process is performed, the OSCi framework performs an automatic schedule control operation (step S41) to determine whether an execution for a schedule is required (step S42). If required, it is determined whether a type of the schedule which represents a start operation, a stop operation, or an update operation (step S43). If the schedule represents a start operation, a bundle corresponding to the schedule starts at a preset time (step S44). If the schedule represents a stop operation, a bundle corresponding to the schedule stops at a preset time (step S45). If the schedule represents an update operation, the electronic device connects to a remote database at a preset time (step S46) to determine whether a new manifest for a bundle corresponding to the schedule is detected (step S47). If a new manifest is detected, the new manifest is retrieved from the remote database (step S48) to update the bundle (step S49).

With respect to automatic update of the framework, each bundle comprises its own manifest. A current installation location of a bundle is retrieved according to a storage location of a manifest of the bundle and a latest manifest of the bundle at the storage location is accessed. The latest manifest at the storage location is compared with a latest manifest installed for the bundle of the OSGi framework. If the manifest at the storage location is newer, the bundle is updated using the manifest at the storage location. The comparison can be preformed at a user-defined time or a preset time.

With respect to the automated schedule control, a schedule for a bundle is performed and a required operation for the schedule is performed at a selected time. When a time for the schedule expires, the framework automatically performs the required operation at the selected time.

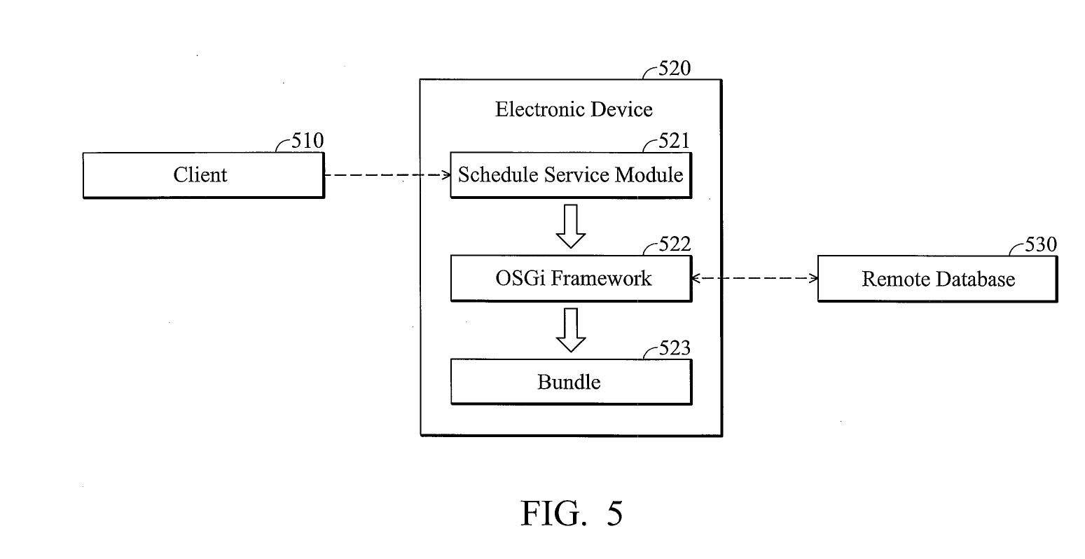

FIG. 5 is a schematic view of an embodiment of a system for automated schedule control.

The system comprises a client 510, an electronic device 520, and a remote database 530. The electronic device 520 further comprises a schedule service module 521, an OSGi framework 522, and a bundle 523. The client 510, by wire or wireless connection, connects to the electronic device 520 and performs an automated schedule control operation using the schedule service module 521, implementing schedule addition, edition, and remove to the bundle 523.

When a schedule appointment process is complete, the OSGi framework 522 perform a schedule appointment process, comprising determining whether an execution for a schedule is required. If an execution for the schedule is required, the OSGi framework 522 determines whether the schedule represents a start operation, a stop operation, or an update operation. If the schedule represents a start operation, the OSGi framework 522 starts the bundle 523 corresponding to the schedule at a preset time. If the schedule represents a stop operation, the OSGi framework 522 stops the bundle 523 corresponding to the schedule at a preset time. If the schedule represents an update operation, the OSGi framework 522 connects to the remote database 530 at a preset time to determine whether a new manifest for the bundle 523 corresponding to the schedule is detected. If a new manifest is detected, the OSGi framework 522 retrieves the new manifest from the remote database 523 and updates the bundle 523.

An embodiment of a method and system for automated schedule control enables the framework to automatically start, stop or update a bundle without a computer device. The framework can automatically detect whether the bundle requires updating and, if required, updates the bundle without manual operations. Thus, alleviating prior art limitations related to the schedule service being incapable of updating the bundle using a start_level service.

Methods and systems of the present disclosure, or certain aspects or portions of embodiments thereof, may take the form of a program code (i.e., instructions) embodied in media, such as floppy diskettes, CD-ROMS, hard drives, firmware, or any other machine-readable storage medium, wherein, when the program code is loaded into and executed by a machine, such as a computer, the machine becomes an apparatus for practicing embodiments of the disclosure. The methods and apparatus of the present disclosure may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for practicing and embodiment of the disclosure. When implemented on a general-purpose processor, the program code combines with the processor to provide a unique apparatus that operates analogously to specific logic circuits.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for automated schedule control, applied to an electronic device capable of an OSCi framework, comprising:
when a schedule appointment process is performed, the OSCi framework performing an automated schedule control operation to determine whether an execution for a schedule is required;
if the execution for the schedule is required, the OSCi framework determining whether the schedule is an update operation;
if the schedule is not an update operation, the OSCi framework performing a start or stop operation for a bundle corresponding to the schedule;
if the schedule is an update operation, the OSCi framework enabling the electronic device to connect to a remote database at a preset time to determine whether a new manifest for the bundle corresponding to the schedule is detected; and
if a new manifest is detected, the OSCi framework retrieving the new manifest from the remote database and updating the bundle according to the new manifest.

2. The method for automated schedule control as claimed in claim 1, wherein updating the bundle further comprises:
retrieving a current installation location of the bundle according to a storage location of the manifest of the bundle;
accessing a latest manifest of the bundle at the storage location;
comparing the latest manifest at the storage location with a latest manifest installed for the bundle of the OSGi framework; and
if the manifest at the storage location is newer, updating the bundle using the manifest at the storage location.

3. The method for automated schedule control as claimed in claim 1, wherein performing the start operation for the bundle corresponding to the schedule starts the bundle corresponding to the schedule at a preset time.

4. The method for automated schedule control as claimed in claim 1, wherein performing the stop operation for the bundle corresponding to the schedule stops the bundle corresponding to the schedule at a preset time.

5. The method for automated schedule control as claimed in claim 1, wherein the schedule appointment process further comprises:
selecting an operation to be preformed;
if a schedule addition operation is performed, selecting a bundle to be added and setting a start time for the bundle;
when the schedule addition operation is completely performed, determining whether the schedule appointment process is repeated; and
if the schedule appointment process is not repeated, waiting for and performing an added schedule.

6. The method for automated schedule control as claimed in claim 5, wherein the schedule appointment process further comprises:
if a schedule edition process is performed, retrieving schedule settings of a bundle to be edited and modifying the schedule settings of the bundle;
when the schedule edition process is performed, determining whether the schedule appointment process is repeated; and
if the schedule appointment process is not repeated, waiting for and performing an edited schedule.

7. The method for automated schedule control as claimed in claim 6, wherein the schedule appointment process further comprises:
if a schedule remove process is performed, retrieving schedule settings of a bundle to be removed and determining whether the schedule settings is removed; and
if the schedule settings is removed, removing the schedule settings of the bundle.

8. A system for automated schedule control, comprising:
an electronic device, further comprising a schedule service module, an OSGi framework, and a bundle; and
a client, by wire or by wireless connection, connecting to the electronic device and enabling the electronic device to connect to a remote database using the OSGi framework to perform a schedule appointment process,
wherein the OSCi framework performs an automated schedule control operation when a schedule appointment process is performed, to determine whether an execution for a schedule is required, and, if the execution for the schedule is required, determine whether the schedule is an update operation, and, if the schedule is not an update operation, perform a start or stop operation for the bundle corresponding to the schedule, and, if the schedule is an update operation, enable the electronic device to connect to a remote database at a preset time to determine whether a new manifest for the bundle corresponding to the schedule is detected, and, if a new manifest is detected, retrieves the new manifest from the remote database and update the bundle according to the new manifest.

9. The system for automated schedule control as claimed in claim 8, wherein the OSGi framework retrieves a current installation location of the bundle according to a storage location of the manifest of the bundle, accesses a latest manifest of the bundle at the storage location, compares the latest manifest at the storage location with a latest manifest installed for the bundle of the OSGi framework, and, if the manifest at the storage location is newer, updates the bundle using the manifest at the storage location.

10. The system for automated schedule control as claimed in claim 9, wherein performing the start operation for the bundle corresponding to the schedule starts the bundle corresponding to the schedule at a preset time.

11. The system for automated schedule control as claimed in claim 9, wherein performing the stop operation for the bundle corresponding to the schedule stops the bundle corresponding to the schedule at a preset time.

12. The system for automated schedule control as claimed in claim 9, wherein the schedule service module selects an operation to be preformed, and, if a schedule addition operation is performed, selects a bundle to be added and sets a start time for the bundle, and, when the schedule addition operation is completely performed, determines whether the schedule appointment process is repeated, and, if the schedule appointment process is not repeated, waits for and performs an added schedule.

13. The system for automated schedule control as claimed in claim 12, wherein the schedule service module retrieves schedule settings of a bundle to be edited and modifies the schedule settings of the bundle if a schedule edition process is performed, and, when the schedule edition process is performed, determines whether the schedule appointment process is repeated, and, if the schedule appointment process is not repeated, waits for and performs an edited schedule.

14. The system for automated schedule control as claimed in claim 13, wherein the schedule service module retrieves schedule settings of a bundle to be removed and determines whether the schedule settings is removed if a schedule remove process is performed, and, if the schedule settings is removed, removes the schedule settings of the bundle.

15. A computer-readable storage medium storing a computer program providing a method for automated schedule control applied to an electronic device capable of an OSCi framework, comprising using a computer to perform the steps of:
codes for performing an automated schedule control operation to determine whether an execution for a schedule is required when a schedule appointment process is performed;
codes for determining whether the schedule is an update operation if the execution for the schedule is required;
codes for performing a start or stop operation for a bundle corresponding to the schedule if the schedule is an update operation;
codes for enabling the electronic device to connect to a remote database at a preset time to determine whether a new manifest for the bundle corresponding to the schedule is detected if the schedule is not an update operation; and
codes for retrieving the new manifest from the remote database and updating the bundle according to the new manifest if a new manifest is detected.

16. The computer-readable storage medium as claimed in claim 15, wherein updating the bundle further comprises:
codes for retrieving a current installation location of the bundle according to a storage location of the manifest of the bundle;
codes for accessing a latest manifest of the bundle at the storage location;
codes for comparing the latest manifest at the storage location with a latest manifest installed for the bundle of the OSGi framework; and
codes for updating the bundle using the manifest at the storage location if the manifest at the storage location is newer.

17. The computer-readable storage medium as claimed in claim 15, wherein performing the start operation for the bundle corresponding to the schedule further comprises codes for starting the bundle corresponding to the schedule at a preset time.

18. The computer-readable storage medium as claimed in claim 15, wherein performing the stop operation for the bundle corresponding to the schedule further comprises codes for stopping the bundle corresponding to the schedule at a preset time.

19. The computer-readable storage medium as claimed in claim 15, wherein the schedule appointment process further comprises:
codes for selecting an operation to be preformed;
codes for selecting a bundle to be added and setting a start time for the bundle if a schedule addition operation is performed;
codes for determining whether the schedule appointment process is repeated when the schedule addition operation is completely performed; and
codes for waiting for and performing an added schedule if the schedule appointment process is not repeated.

20. The computer-readable storage medium as claimed in claim 19, wherein the schedule appointment process further comprises:
codes for retrieving schedule settings of a bundle to be edited and modifying the schedule settings of the bundle if a schedule edition process is performed;
codes for determining whether the schedule appointment process is repeated when the schedule edition process is performed; and
codes for waiting for and performing an edited schedule if the schedule appointment process is not repeated.

21. The computer-readable storage medium as claimed in claim 20, wherein the schedule appointment process further comprises:
codes for retrieving schedule settings of a bundle to be removed and determining whether the schedule settings is removed if a schedule remove process is performed; and
codes for removing the schedule settings of the bundle if the schedule settings are removed.
